(19) United States
(12) Patent Application Publication
(10) Pub. No.: US 2026/0111867 A1
(43) Pub. Date: Apr. 23, 2026

(54) COMMODITY SALES DATA PROCESSING APPARATUS AND METHOD OF CONTROLLING COMMODITY SALES DATA PROCESSING APPARATUS

(71) Applicant: Toshiba Tec Kabushiki Kaisha, Tokyo (JP)

(72) Inventor: Seiichi SHIRATO, Mishima Shizuoka (JP)

(21) Appl. No.: 19/227,106

(22) Filed: Jun. 3, 2025

(30) Foreign Application Priority Data
Oct. 18, 2024 (JP) 2024-182397

(51) Int. Cl. G06Q 20/20; G07G 1/00

(52) U.S. Cl. CPC G06Q 20/208; G07G 1/0045

(57) ABSTRACT

According to one embodiment, a commodity sales data processing apparatus includes a communication interface, a storage unit, and a control unit. The control unit receives a commodity code of an item being registered for purchase, extracts commodity information associated with the commodity code, registers the commodity code and the extracted commodity information in a transaction file, and causes commodity information related to the item to be displayed on a commodity registration screen. When the control unit receives a cancelation request for removing an item from the sales transaction, it outputs a cancelation notification to a clerk terminal and then indicates a deletion of the item from the transaction file after receiving a clerk confirmation. The control unit is configured to continue to receive commodity codes of other items being registered in the sales transaction after the cancelation notification has been output but before receiving of the clerk confirmation.

### CROSS-REFERENCE TO RELATED APPLICATION

This application is based upon and claims the benefit of priority from Japanese Patent Application No. 2024-182397, filed Oct. 18, 2024, the entire contents of which are incorporated herein by reference.

### FIELD

Embodiments described herein relate generally to a commodity sales data processing apparatus and a method of controlling the same.

### BACKGROUND

In stores such as supermarkets, commodity sales data processing apparatuses, sometimes called self-service POS (Point Of Sales) terminals, by which merchandise registration operations and payment operations are performed by customers themselves are installed. With such a commodity sales data processing apparatus, for the canceling of an item which was previously registered, the execution of the cancellation by the customer himself or herself is often disabled as a security measure against fraud, theft, and the like, and therefore cancellation must be executed by a clerk who must go to the commodity sales data processing apparatus to perform or permit the cancellation.

However, in the related-art technique described above, when canceling an item, the customer has to stop (pause) the registration operation until the cancel operation is completed by the clerk at the commodity sales data processing apparatus, and thus there is room for improvement in convenience and efficiency of checkout operations.

### BRIEF DESCRIPTION OF THE DRAWINGS

FIG. 1 depicts a commodity sales data processing system according to an embodiment.

FIG. 2 is a perspective view of a self-service POS terminal according to an embodiment.

FIG. 3 is a diagram of a hardware configuration of a self-service POS terminal according to an embodiment.

FIG. 4 is a diagram showing an example of a data configuration of a commodity registration file related to an embodiment.

FIG. 5 is a diagram of a hardware configuration of a clerk terminal according to an embodiment.

FIG. 6 depicts a functional configuration of a self-service POS terminal and a clerk terminal according to an embodiment.

FIG. 7 is a diagram showing an example of a commodity registration screen displayed on a self-service POS terminal according to an embodiment.

FIG. 8 is a diagram showing an example of a commodity registration screen displayed on a self-service POS terminal according to an embodiment.

FIG. 9 is a diagram showing an example of a commodity registration screen displayed on a self-service POS terminal according to an embodiment.

FIG. 10 is a flowchart of processing performed by a self-service POS terminal of an embodiment.

FIG. 11 is a sequence diagram showing an example of cancel processing performed by a self-service POS terminal and a clerk terminal of an embodiment.

### DETAILED DESCRIPTION

A problem to be solved by the present disclosure is to provide a commodity sales data processing apparatus for a retail transaction processing system and a method of controlling the same for improving existing such apparatuses and systems by enabling a more efficient performance of work associated with registering commodities when an item cancellation is requested or necessary.

In general, according to one embodiment, a commodity sales data processing apparatus includes a communication interface connectable to a clerk terminal apparatus, a storage unit, and a control unit. The control unit is configured to: receive a commodity code of an item being registered for purchase in a sales transaction, extract commodity information associated with the received commodity code from a commodity master, register the commodity code and the extracted commodity information for the item in a transaction file associated with the sales transaction in the storage unit, cause commodity information related to the item to be displayed on a commodity registration screen, receive a cancelation operation requesting a cancelation (removal) of the item from the sales transaction, output a cancelation notification to the clerk terminal apparatus via the communication interface, and indicate a deletion of the registered item in the transaction file for the sales transaction upon receiving a clerk cancelation confirmation instruction. The control unit is further configured to receive commodity codes of other items being registered for purchase in the sales transaction after the cancelation notification has been output but before receiving of the clerk cancelation confirmation instruction.

A commodity sales data processing apparatus and a method of controlling the same according to certain example embodiments will be described with reference to the drawings. In the described embodiments below, a self-service point-of-sale (POS) terminal used in a store such as a supermarket will be described as one possible example. It should be noted that the present disclosure is not limited by the specific example embodiment.

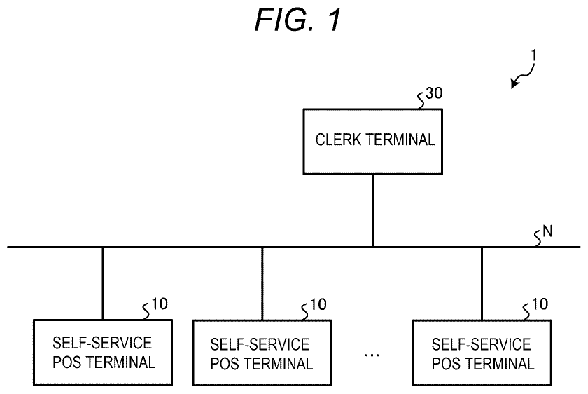

FIG. 1 is a diagram showing an example of the commodity sales data processing system according to an embodiment. As shown in FIG. 1, the commodity sales data processing system 1 has self-service POS terminal 10 and a clerk terminal 30. The self-service POS terminal 10 and the clerk terminal 30 are connected to each other so as to communicate with each other via a wired or wireless network N.

As the network N, the Internet, a VPN (virtual private network), a LAN (local area network), a public telecommunication network, a mobile communication network, or the like can be used alone, or in any combination with each other. In the present embodiment, it is assumed that a LAN provided in a store is an example of the network N. The total number of self-service POS terminals 10 and the number of clerk terminals 30 in the commodity sales data processing system 1 are not limited to those of the illustrated example.

The self-service POS terminal 10 is an example of the commodity sales data processing apparatus in the present disclosure. The self-service POS terminal 10 is a POS terminal with which registration processing of registering a commodity for purchase and settlement (payment) processing the registered item(s) are performed by a customer without substantial intervention by a store clerk.

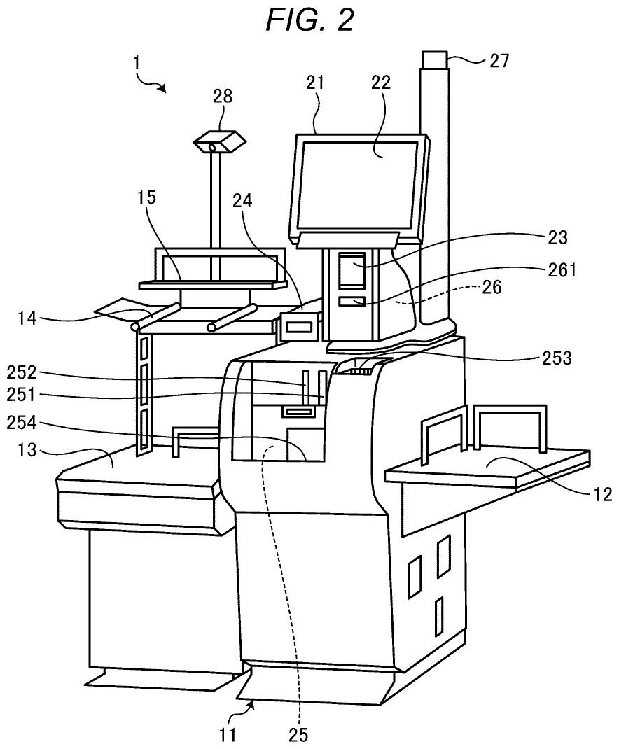

FIG. 2 is a perspective view of the self-service POS terminal 10 according to the embodiment. As shown in FIG. 2, the self-service POS terminal 10 has a main body part 11, a first loading table 12 installed on a side of the main body part 11, and a second loading table 13 on a side of the main body part 11 opposite the first loading table 12. Input-output equipment which performs input and output of a variety of types of information to and from the self-service POS terminal 10 is installed in the main body part 11.

Specifically, the main body part 11 is provided with a display unit 21, an operation unit 22, a scanner 23, a card reader writer 24, a change dispenser 25, a printer 26, and a warning lamp 27.

The display unit 21 is a display device such as an LCD (Liquid Crystal Display). The display unit 21 displays a variety of screens under the control of a CPU 101 (see FIG. 2). It should be noted that the display unit 21 is an example of a customer-side screen in the present disclosure.

The operation unit 22 receives a variety of types of input from the user. The operation unit 22 is, for example, a touch panel disposed so as to be stacked on a display surface of the display unit 21. It should be noted that the operation unit 22 may be an input device such as a keyboard or a pointing device.

The scanner 23 is a so-called a stationary scanner having an imaging window and an imaging unit not shown and disposed in the back of the imaging window. The imaging unit takes an image of a code symbol such as a barcode attached to a commodity which is put over the imaging window by a customer when the customer registers the commodity to be purchased. It should be noted that a commodity code as identification information capable of identifying a class (commodity item) of the commodity is registered in the code symbol. The scanner 23 decodes the information included in the code symbol thus imaged to obtain the commodity code. The self-service POS terminal 10 collates the decoded commodity code with information in a commodity master 1042 (see FIG. 2) to acquire commodity information of the commodity out over the scanner 23, and then registers the commodity information of that commodity in a commodity registration file 1043 (see FIG. 2).

It should be noted that the self-service POS terminal 10 may be provided with a handy scanner of a handheld type not shown in addition to the scanner 23. The handy scanner reads the code symbol attached to a commodity when it is difficult to put the code symbol attached to the commodity over the scanner 23 such as when the commodity is heavy in weight or when the commodity is large in size.

The card reader writer 24 reads information necessary for settlement processing from a card medium such as a reward card, an electronic money card, or a credit card. Further, the card reader writer 24 performs writing of information to the card medium such as a credit card or a prepaid-type or postpaid-type electronic money card. For example, the card reader writer 24 reads the information to be used for a credit settlement or an electronic settlement, and then outputs the information to a control unit 100. Further, the card reader writer 24 receives an instruction from the control unit 100, and then adds points corresponding to the purchase amount to the points recorded in the reward card.

The change dispenser 25 receives a bill or a coin dropped therein by the customer as the purchase amount when the customer selects the cash settlement. The change dispenser 25 pays out a change, as bills or coins, obtained by subtracting a total amount of the commodities from a total amount of the bills and the coins dropped therein. The change dispenser 25 is provided with a bill slot 251 in which a bill is inserted, a bill discharge port 252 from which a bill as a change is discharged, a coin slot 253 in which a coin is dropped, and a coin discharge port 254 from which a coin as a change is discharged.

The printer 26 prints a result of the settlement processing on a receipt, and then issues the receipt from a receipt issuance port 261.

The warning lamp 27 is disposed in an upper end portion of a columnar pole erected at the back of the main body part 11. The warning lamp 27 includes, for example, a red LED that lights or blinks when an error occurs at the self-service POS terminal 10 for calling for a clerk, and so on.

The first loading table 12 is for a commodity to be registered. For example, a shopping bag or basket containing the commodities to be registered is placed on the first loading table 12.

The second loading table 13 is for the items already read by the scanner 23, that for items already registered in the registration operation. Hooks 14 are for a plastic store bag or the customer's own bag are disposed above the second loading table 13.

A third loading table 15 is disposed above the hooks 14. The third loading table 15 is in this example for a commodity or item (also referred to as a canceled commodity or canceled item) that is to be excluded from the purchase was after it has already been read/registered by the scanner 23 or the like. That is, the third loading table 15 can be for registered commodities but those that are to be canceled (de-registered) from the transaction.

An imaging unit 28 is disposed above the third loading table 15. The imaging unit 28 is an electronic camera having an imaging element such as a CCD, and takes images within an imaging range including the third loading table 15 from above. It should be noted that the configuration in which the imaging unit 28 is held by a support member, such as a stand, disposed at the back of the third loading table 15 is adopted in FIG. 2, but the attachment position and the attachment method of the imaging unit 28 are not limited to these. For example, the imaging unit 28 may be attached to an upper end portion of the display unit 21 or the pole to which the warning lamp is disposed. Further, the imaging range of the imaging unit 28 may include the main body part 11 and the whole of the self-service POS terminal 10.

Going back to FIG. 1, the clerk terminal 30 is a terminal device to be operated by a store clerk (hereinafter also referred to as an attendant). The clerk terminal 30 may be a stationary terminal device or may be a portable terminal device. In the former case, for example, the clerk terminal 30 is disposed in an area where the self-service POS terminal 10 is located in the store, or in the vicinity of that area.

The clerk terminal 30 receives a variety of types of information transmitted from the self-service terminal 10. In general, the clerk who operates or monitors the clerk terminal 30 watches the state of the self-service POS terminal 10 and may move to a self-service terminal 10 to support a customer transaction at the self-service POS terminal 10 as necessary or appropriate.

An example configuration of the self-service POS terminal 10 and the clerk terminal 30 will be described.

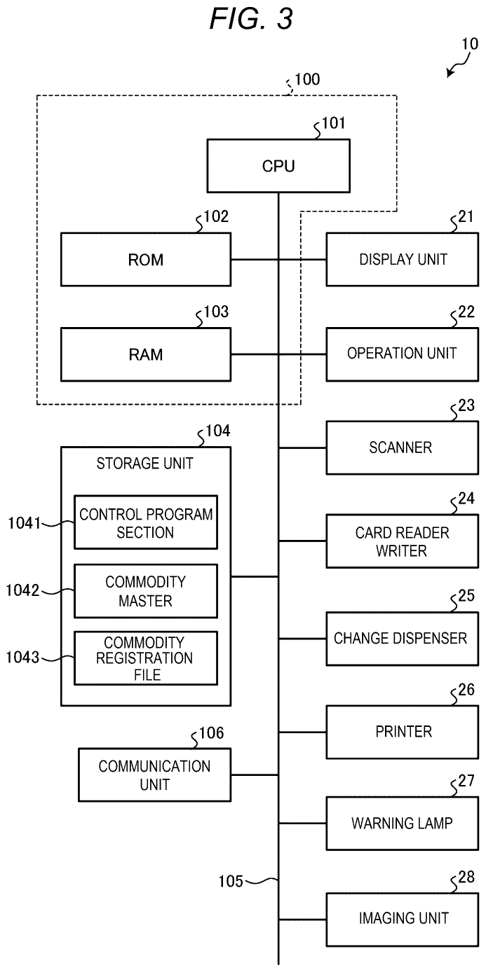

FIG. 3 is a diagram showing an example of a hardware configuration of the self-service POS terminal 10 according to the embodiment. As shown in FIG. 3, the self-service POS terminal 10 is provided with the CPU (Central Processing Unit) 101, a ROM (Read Only Memory) 102, a RAM (Random Access Memory) 103, and a storage unit 104.

The CPU 101 is an example of a processor, and integrally controls each unit of the self-service POS terminal 10. The ROM 102 stores a variety of programs. The RAM 103 is a work space in which the programs and a variety of types of data are developed.

The storage unit 104 is a nonvolatile memory such as an HDD (Hard Disc Drive) or a flash memory in which storage information is held even when turning off the power. The storage unit 104 is provided with a control program section 1041, a commodity master 1042, and a commodity registration file 1043.

The control program section 1041 stores a variety of control programs for controlling the self-service POS terminal 10. The CPU 101, the ROM 102, the RAM 103, and the storage unit 104 are coupled to each other via a bus 105. The CPU 101, the ROM 102, and the RAM 103 constitute a control unit 100 having a computer configuration. That is, the control unit 100 executes control processing of the self-service POS terminal 10 by the CPU 101 operating with the program which is stored in the ROM 102 or the storage unit 104, and is developed in the RAM 103.

The commodity master 1042 is a master file which stores the commodity information such as commodity names and prices of commodities as a sales target. The commodity master 1042 stores the commodity information such as the commodity name and a unit price of the commodity corresponding to the commodity code in association with the commodity code capable of identifying the class of the commodity to be sold in the store.

Further, the commodity master 1042 stores the class of the commodity corresponding to the commodity code and a feature value representing an appearance (characteristic appearance) of the commodity in association with the commodity code. Here, a feature value is collation information for when identifying the class or the like of the commodity using a generic object recognition technique.

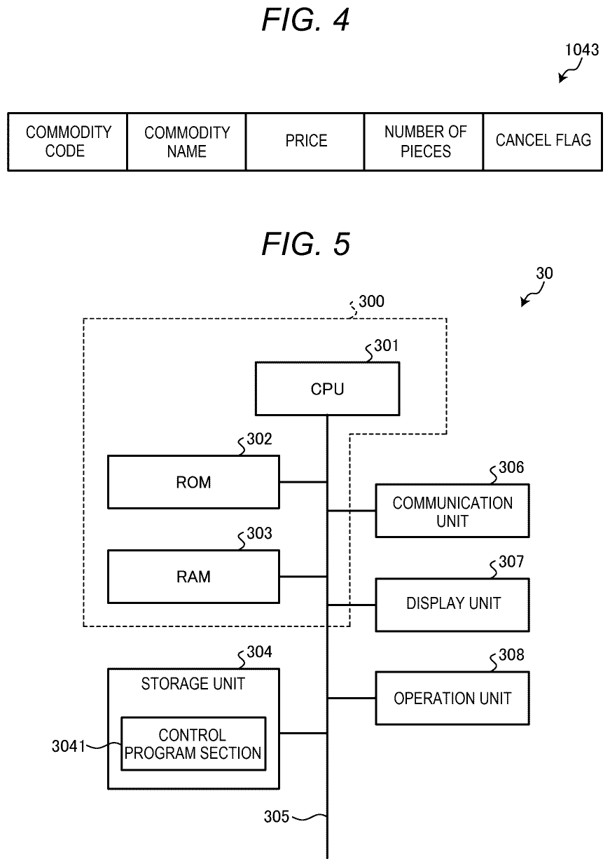

The commodity registration file 1043 is a file which stores information related to commodities registered in one transaction. FIG. 4 is a diagram showing an example of a data configuration of the commodity registration file 1043 related to the embodiment. As shown in FIG. 4, the commodity registration file 1043 stores, for example, the commodity name, the price, the registered number of pieces/instances, and a cancel flag in association with the commodity code of the registered commodity. The commodity registered in the commodity registration file 1043 is also referred to as a registered commodity.

Here, the commodity name and the price are derived from the commodity information stored in the commodity master 1042. The number of pieces/instances refers to the number of registered commodities having the same commodity number/code. For example, when commodities having the same commodity code are registered a plurality of times, the number of registrations is referred to as the number of instances/pieces of that commodity or commodity code.

The cancel flag is information for identifying whether the commodity is the cancel target. For example, the cancel flag is binary information which takes “1” when the flag is valid (also referred to as an ON state), and “0” when the flag is invalid (also referred to as an OFF state).

Specifically, when the cancel flag is in the OFF state, the control unit 100 of the self-service POS terminal 10 determines that the commodity is not the cancel target, and is in the state in which the registration is valid. Further, when the cancel flag is in the ON state, the control unit 100 of the self-service POS terminal 10 determines that the commodity is the cancel target.

Going back to FIG. 3, the control unit 100 is coupled to a communication unit 106 via the bus 105. The communication unit 106 is a wired or wireless communication interface connectable to the network N. The control unit 100 communicates with an external apparatus such as the clerk terminal 30 or a store server not shown via the communication unit 106.

The store server performs, for example, update of the commodity master 1042 on the self-service POS terminal 10. Further, when the customer selects a cashless settlement such as a credit settlement, an electronic money settlement, or a code settlement, the store server may be a relay device for coupling the self-service POS terminal 10 and a settlement server not shown for performing each of the cashless settlements in some cases.

Further, the control unit 100 is coupled to the display unit 21, the operation unit 22, the scanner 23, the card reader writer 24, the change dispenser 25, the printer 26, the warning lamp 27, and the imaging unit 28 via the bus 105. An outline of the input-output equipment is as described above.

FIG. 5 is a diagram showing an example of a hardware configuration of the clerk terminal 30 according to the embodiment. As shown in FIG. 5, the clerk terminal 30 is provided with a CPU 301, a ROM 302, a RAM 303, and a storage unit 304.

The CPU 301 is an example of a processor, and integrally controls each unit of the clerk terminal 30. The ROM 302 stores a variety of programs. The RAM 303 is a work space in which the programs and a variety of types of data are developed.

The storage unit 304 is a nonvolatile memory such as an HDD or a flash memory in which storage information is held even when turning off the power. The storage unit 304 is provided with, for example, a control program section 3041.

The control program section 3041 stores a variety of control programs for controlling the clerk terminal 30. The CPU 301, the ROM 302, the RAM 303, and the storage unit 304 are coupled to each other via a bus 305. The CPU 301, the ROM 302, and the RAM 303 constitute a control unit 300 having a computer configuration. That is, the control unit 300 executes control processing of the clerk terminal 30 by the CPU 301 operating with the program which is stored in the ROM 302 or the storage unit 304, and is developed in the RAM 303.

Further, the control unit 300 is coupled to a communication unit 306, a display unit 307, and an operation unit 308 via the bus 305.

The communication unit 306 is a wired or wireless communication interface connectable to the network N. The control unit 300 communicates with an external apparatus such as the self-service POS terminal 10 or the store server not shown via the communication unit 306.

The display unit 307 is a display device such as an LCD. The display unit 307 displays a variety of types of information under the control of the control unit 300. The operation unit 308 is an input device such as a keyboard or a pointing device. The operation unit 308 outputs an operation content input via the input device to the control unit 300. It should be noted that the operation unit 308 may be a touch panel provided to the display unit 307.

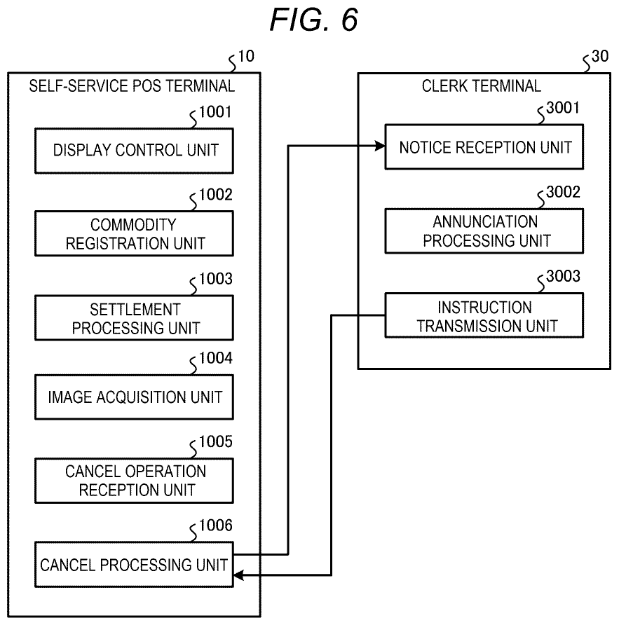

FIG. 6 is a diagram showing an example of a functional configuration of the self-service POS terminal 10 and the clerk terminal 30 according to the embodiment.

The control unit 100 of the self-service POS terminal 10 functions as a display control unit 1001, a commodity registration unit 1002, a settlement processing unit 1003, an image acquisition unit 1004, a cancel operation reception unit 1005, and a cancel processing unit 1006 by the CPU 101 operating with the control program stored in the ROM 102 or the storage unit 104. It should be noted that some or all of these functions described as implemented by software may be realized by hardware such as a dedicated circuit.

The display control unit 1001 is an example of a display section. The display control unit 1001 makes the display unit 21 display the variety of types of screens. For example, the display control unit 1001 makes the display unit 21 display the operation screen for assisting an operation related to commodity purchase. Further, the display control unit 1001 cooperates with other functional configurations to make the display unit 21 display the variety of types of screens.

The commodity registration unit 1002 is an example of a registration section and the display section. The commodity registration unit 1002 executes registration processing of registering the commodity as the purchase target. Further, the commodity registration unit 1002 cooperates with the display control unit 1001 to display an operation screen (a commodity registration screen) for assisting the registration processing of the commodity.

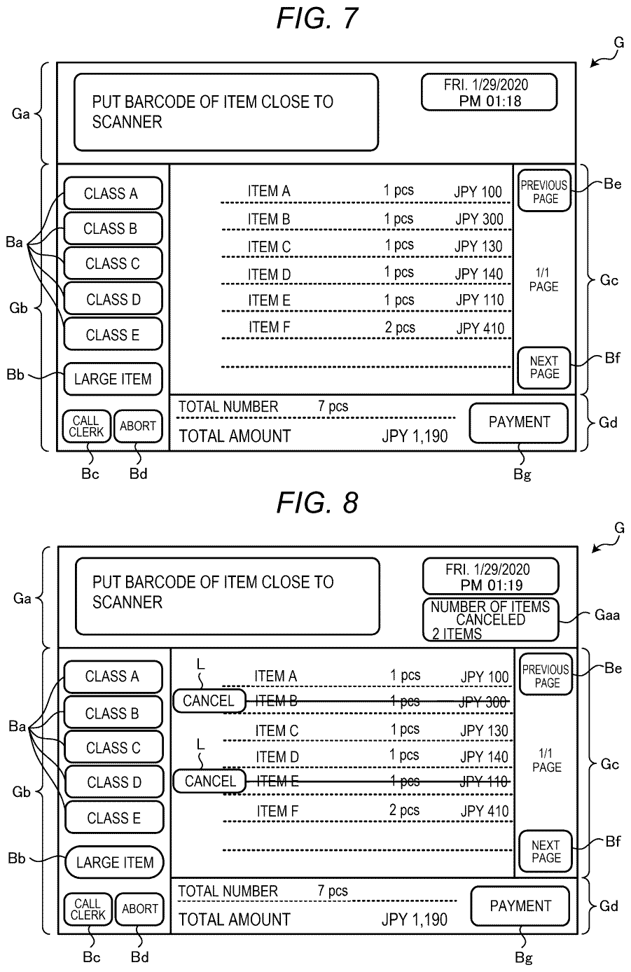

FIG. 7 is a diagram showing an example of a commodity registration screen displayed on the self-service POS terminal 10 according to the embodiment. As shown in FIG. 7, a commodity registration screen G has an information region Ga, an operation region Gb, a commodity display region Gc, and a total display region Gd.

The information region Ga is a region for displaying a variety of types of information to the operator. For example, in the information region Ga, information such as an operation method and a current date is displayed.

The operation region Gb is a region for displaying a variety of operators related to an operation of the self-service POS terminal 10. For example, in the operation region Gb, operators such as a selection button Ba, an operation button Bb, a calling button Bc, and an abort button Bd for terminating a transaction are displayed.

The selection button Ba is an operator for selecting the commodity as the registration target, and is disposed, for example, for each class of the commodity. When the commodity registration unit 1002 receives the selection operation of the selection button Ba, the commodity registration unit 1002 cooperates with the display control unit 1001 to display a commodity selection screen (not shown) which displays the commodities belonging to the class of the selection button Ba thus selected as a list. Then, when a commodity is selected from the commodity selection screen, the commodity registration unit 1002 receives, as a registration target, the commodity code of the commodity thus selected. It should be noted that the selection button Ba is operated when registering, for example, a commodity to which a code symbol is not attached.

The operation button Bb is an operator which is operated when reading the code symbol using the handy scanner of the handheld type. When the commodity registration unit 1002 receives an operation of the operation button Bb, the commodity registration unit 1002 validates reading of the code symbol with the handy scanner. It should be noted that the operation button Bb is operated when registering, for example, a commodity large in size.

The calling button Bc is an operator for calling the clerk. When the commodity registration unit 1002 receives an operation of the calling button Bc, the commodity registration unit 1002 transmits a calling notice including the identification information (a terminal ID) capable of identifying the own self-service POS terminal 10 to the clerk terminal 30.

The abort button Bd is an operator for instructing to terminate the transaction. When the commodity registration unit 1002 receives an operation of the abort button Bd, the commodity registration unit 1002 terminates the transaction, and switches the display to a standby screen not shown.

The commodity display region Gc is a region for displaying the commodity information of the registered commodities as a list. The commodity display region Gc includes items such as commodity name, the number of instances/pieces, and the amount due. Here, the amount due is a value obtained by multiplying the unit price of each commodity by the number of registered instances of that commodity. FIG. 7 shows the state in which 7 items of a commodity A to a commodity F are registered, in which these items are displayed in the registration order from the top.

It should be noted that it is assumed that when the commodities registered do not fall within a page of the commodity display region Gc, page buttons Be, Bf are operated to feed the page forward or backward to make it possible to confirm all the commodities registered.

In the total display region Gd, the total number of registered items and the total amount due for the commodities registered are displayed. Further, in the commodity display region Gc, a payment button Bg for instructing the payment of the commodities is disposed.

The commodity registration unit 1002 cooperates with the operation unit 22 and the scanner 23 to execute registration processing of the commodities being purchased by the customer.

For example, when the commodity code is read by the scanner 23 or a handy scanner from the code symbol attached to a commodity, the commodity registration unit 1002 acquires the commodity information corresponding to that commodity code from the commodity master 1042. Subsequently, the commodity registration unit 1002 stores (registers) the commodity code thus acquired in the commodity registration file 1043 in association with the commodity information corresponding to that commodity code.

For example, when the commodity registration unit 1002 receives an operation of selecting a commodity as the registration target via the operation unit 22 (the selection button Ba), the commodity registration unit 1002 acquires, from the commodity master 1042, the commodity information corresponding to the commodity code of the commodity thus selected, and then stores the commodity information in the commodity registration file 1043. Further, when the commodity registration unit 1002 receives an operation of inputting the commodity code via a numerical keypad or the like, the commodity registration unit 1002 acquires the commodity information corresponding to the commodity code from the commodity master 1042, and then stores the commodity information in the commodity registration file 1043.

When the commodity registration unit 1002 stores (registers) the commodity information in the commodity registration file 1043, the commodity registration unit 1002 displays the commodity information of the registered commodity in the commodity display region Gc in cooperation with the display control unit 1001. Thus, the customer who operates the self-service POS terminal 10 can easily confirm the commodity thus registered by looking at the commodity display region Gc.

Going back to FIG. 6, the settlement processing unit 1003 executes the settlement processing of the commodities thus registered. For example, when the end of the commodity registration or the start of the settlement processing is instructed by an operation of the payment button Bg shown in FIG. 7, the settlement processing unit 1003 executes the settlement processing of the commodities registered in one transaction.

The settlement processing unit 1003 calculates the total amount due for the registered commodities based on the commodity information and the number of instances of each commodity thus registered. Here, the total amount can be calculated by adding the amounts, obtained by multiplying the price of the commodity corresponding to the commodity code by the registered number of instances of that commodity throughout all the registered commodities.

Further, the settlement processing unit 1003 executes the settlement processing of making the settlement of the total amount thus calculated with the payment method designated by the customer. As the payment method, it is possible to designate a code settlement using a two-dimensional code or the like in addition to a cash settlement using the change dispenser 25 and a card settlement (electronic settlement) using the card reader writer 24. It should be noted that the settlement processing unit 1003 may make the display unit 406 display a screen for selecting the payment method when performing the settlement processing in cooperation with the display control unit 1001.

Further, when the settlement processing is completed, the settlement processing unit 1003 controls the printer 26 to output the breakdown of the transaction to a paper medium such as a receipt.

The image acquisition unit 1004 is an example of an acquisition section. The image acquisition unit 1004 acquires the image taken by the imaging unit 28. Specifically, the image acquisition unit 1004 acquires an image of a commodity placed on the third loading table 15. A commodity so placed on the third loading table may be referred to as the cancel target. In this context, a cancel target is an item that the customer no longer wishes to purchase, even though the item was previously registered in the transaction. That is, the customer wishes to remove the item from the transaction after previously registering the item for purchase.

The cancel operation reception unit 1005 is an example of a receiving section. The cancel operation reception unit 1005 receives, from the customer, a cancel operation for removing a commodity already registered for purchase from the transaction.

Specifically, the cancel operation reception unit 1005 receives, via the operation unit 22, a cancel operation designating a commodity as the cancel target. For example, the cancel operation reception unit 1005 receives an operation designating a commodity as a cancel target by a selection from the commodities displayed in the commodity display region Gc in the commodity registration screen G (see FIG. 7). In general, the method of designating a commodity as a cancel target in the commodity display region Gc or otherwise does not particularly matter. For example, a cancel operation can be a touch operation or a long-press operation performed on a displayed commodity name or the like, the cancel operation reception unit 1005 receives the corresponding commodity code of the commodity so designated or selected.

The cancel operation reception unit 1005 may receive a cancel operation based on an image acquired by the image acquisition unit 1004. Specifically, the cancel operation reception unit 1005 detects a region (a commodity region) in the image acquired by the image acquisition unit 1004 (a commodity region) in which a commodity is shown. In this case, the cancel operation reception unit 1005 extracts a feature value representing a characteristic appearance feature of an item in the detected commodity region from, and calculates a degree of similarity by comparing the feature value thus extracted with the feature values stored in the commodity master 1042 for different items. In general, it is possible to use a known technique such as an object detection technique or the generic object recognition technique in the processing related to the detection of the commodity region, the extraction of the feature value, and the calculation of the degree of similarity.

Further, when the cancel operation reception unit 1005 identifies (recognizes) a commodity code of a commodity for which the degree of similarity of the feature value is equal to or greater than a threshold value and the closest match among possible commodities, the cancel operation reception unit 1005 treats the identified commodity code as commodity code of a canceled commodity (a cancel target or a cancel commodity). In other words, the cancel operation reception unit 1005 treats, as a cancel operation (or a cancel request operation), the customer simply placing a commodity on the third loading table 15. Thus, since the customer can perform this cancel operation in this manner by placing an item on the third loading table 15, an improvement in operability can be achieved since separate designation (such as by menu or screen operation) is unnecessary.

In general, the cancel operation reception unit 1005 checks whether the commodity code of a commodity identified based on the comparison result of the feature value has already been registered, and may receive only a commodity code of an already registered commodity, that is, when the cancel operation reception unit 1005 determines that the commodity code was previously registered in the transaction. Thus, it is possible for the cancel operation reception unit 1005 to avoid a scenario in which a commodity which has not been registered at all is placed on the third loading table 15 and then regarded or treated as a cancel target.

Further, it is assumed here that the cancel operation reception unit 1005 monitors the image acquired by the image acquisition unit 1004 constantly or at fixed interval (e.g., every 2 seconds), and performs a cancel operation for each commodity region identified whenever the cancel operation reception unit 1005 detects a plurality of commodity regions in an image or series of images. It should be noted that in order to prevent a cancel operation being performed repeatedly for the same commodity, it is possible to adopt a configuration in which the cancel operation reception unit 1005 counts the number of items by commodity codes, and thus does not perform the cancel operation when the number of items for each of the previously detected commodity codes does not change.

The cancel processing unit 1006 is an example of a cancel section and the display section. The cancel processing unit 1006 executes processing for excluding the cancel commodity from the purchase. Specifically, when the cancel operation reception unit 1005 receives the cancel operation, the cancel processing unit 1006 searches the commodity registration file 1043 for the commodity code of the cancel commodity designated by that operation. Then, the cancel processing unit 1006 sets the cancel flag associated with the commodity code subjected to the search to the ON state.

The cancel processing unit 1006 then displays the commodity the cancel flag of which is set to the ON state in a discriminable state in cooperation with the display control unit 1001. For example, as shown in FIG. 8, the cancel processing unit 1006 displays the cancel commodity in a discriminable manner in the commodity registration screen G.

FIG. 8 is a diagram showing an example of a commodity registration screen displayed on the self-service POS terminal 10 according to an embodiment. In FIG. 8, a display example is shown in which a commodity B and a commodity E are set to be cancel targets out of all the registered commodities displayed in the commodity display region Gc in the commodity registration screen G in FIG. 7.

As shown in FIG. 8, the cancel processing unit 1006 displays commodity B and commodity E as the cancel targets in a discriminable (identifiable) manner. For example, the cancel processing unit 1006 adds a strike-through to the information related to the commodity B and the commodity E displayed in the commodity display region Gc. Further, for example, the cancel processing unit 1006 adds information (a label L) indicating that the commodity is the cancel target in association with the information related to the commodity B and the commodity E displayed in the commodity display region Gc. Thus, the cancel processing unit 1006 displays, in a discriminable manner, that the commodity is the cancel target.

Further, the cancel processing unit 1006 displays cancel information Gaa indicating the total number of commodities being cancelled (also referred to as the number of cancel commodities) in the information region Ga. For example, in FIG. 8, since two items, that is, the commodity B and the commodity E, are the cancel target, the cancel processing unit 1006 displays the cancel commodity information Gaa indicating that the number of cancel commodities is two in the information region Ga.

Thus, the customer who operates the self-service POS terminal 10 can easily confirm the cancel commodities and the number of cancel commodities by looking at the label L or the like displayed in the information region Ga or the commodity display region Gc.

Further, when the cancel operation reception unit 1005 receives the cancel operation, the cancel processing unit 1006 transmits, to the clerk terminal 30, a cancel notice of giving notice that the cancel operation was performed.

On this occasion, the cancel processing unit 1006 may transmit a variety of types of information included in the cancel notice (or together with the cancel notice). For example, the cancel processing unit 1006 may transmit a terminal ID of the own self-service POS terminal 10 included in the cancel notice. For example, the cancel processing unit 1006 may transmit information related to the cancel commodity such as the commodity name or other related information of the cancel commodity included in the cancel notice. Specifically, the cancel processing unit 1006 transmits the commodity information such as the commodity name (or related information) of the commodity the cancel flag of which is set to the ON state included in the cancel notice. The cancel processing unit 1006 may also transmit the image acquired by the image acquisition unit 1004, that is, the image of the cancel commodity, included in the cancel notice.

It should be noted that the cancel processing unit 1006 may also light or blink the warning lamp 27 after the cancel operation reception unit 1005 receives the cancel operation.

Further, when the cancel processing unit 1006 receives instruction information of instructing deletion of the registration of the cancel commodity (also referred to as a deletion instruction) from the clerk terminal 30 as a response to the cancel notice, the cancel processing unit 1006 executes the deletion of the registration of the cancel commodity. Specifically, when the cancel processing unit 1006 receives the deletion instruction from the clerk terminal 30, the cancel processing unit 1006 deletes a data entry of the commodity the cancel flag of which is set to the ON state from the commodity registration file 1043.

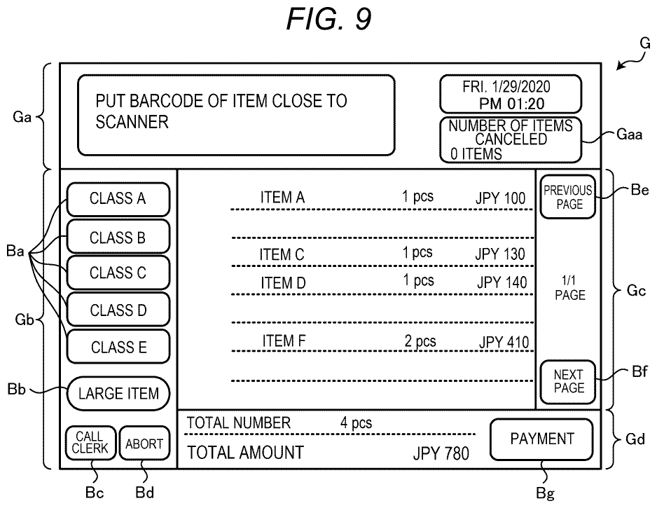

When the cancel processing unit 1006 executes the deletion of the registration of the cancel commodity, the cancel processing unit 1006 displays the state of the registered commodity after the deletion of the registration on the commodity registration screen G in cooperation with the display control unit 1001. For example, as shown in FIG. 9, the cancel processing unit 1006 reflects the state of the commodity registration file 1043 after the deletion of the registration on the commodity registration screen G.

Here, FIG. 9 is a diagram showing an example of the commodity registration screen displayed on the self-service POS terminal 10 according to the embodiment. FIG. 9 shows the state after the deletion of the registration of the commodity B and the commodity E, which were set as the cancel commodities via the commodity registration screen G in FIG. 8.

As shown in FIG. 9, in the commodity display region Gc of the commodity registration screen G, the region in which the information related to the commodity B and the commodity E was displayed is now displayed in a blank state. Further, due to the deletion of the registration of the commodity B and the commodity E, the number of commodities of the cancel commodity information Gaa displayed in the information region Ga is updated to “0.” Further, due to the deletion of the registration of the commodity B and the commodity E, the total number of registered items and the total amount due displayed in the total display region Gd are updated.

Thus, the customer at the self-service POS terminal 10 can easily confirm that the deletion of the registration of the cancel commodities was executed by looking at the information region Ga, the commodity display region Gc, and the total display region Gd in the commodity registration screen G.

It should be noted that in FIG. 9, there is adopted a display configuration in which the region in which the cancel commodities were displayed is left as a blank in the commodity display region Gc, but this is not a limitation, and it is possible to adopt a display configuration in which a blank is skipped or omitted. However, when the display position of the registered commodity displayed in the commodity display region Gc changes suddenly in the middle of, for example, the registration of the commodity, there is a possibility that the customer is confused, and therefore, it is preferable to keep the display position in the commodity display region Gc even when the registration of the cancel commodity has been deleted.

Further, the cancel processing unit 1006 may have a configuration for preventing the settlement processing by the settlement processing unit 1003 until the deletion of the registration of the cancel commodity is performed. Specifically, when a commodity the cancel flag of which is in the ON state still exists in the commodity registration file 1043, the cancel processing unit 1006 may prevent the settlement processing by the settlement processing unit 1003.

For example, the cancel processing unit 1006 may prevent the settlement processing by invalidating the payment button Bg of the commodity registration screen G. Further, the cancel processing unit 1006 may prevent the settlement processing by invalidating the function of the settlement processing unit 1003.

Thus, in the self-service POS terminal 10, since it is possible to prevent the settlement processing from being executed before the deletion of the registration of the cancel commodity is executed, that is, in a state in which the total transaction amount is not fixed, it is possible to more surely perform the settlement processing for a transaction.

It should be noted that it is assumed here that even when a commodity the cancel flag of which is in the ON state exists in the commodity registration file 1043, the function of the commodity registration unit 1002 is still maintained. Thus, the customer who operates the self-service POS terminal 10 can continue to execute the registration processing of commodities without waiting for the deletion of the registration of the cancel commodity to be performed by clerk operation. Thus, operations are not unnecessarily delayed even when a customer is performing or intending to perform a cancel operation of a commodity.

The control unit 300 of the clerk terminal 30 functions as a notice reception unit 3001, an annunciation (announcement) processing unit 3002, and a deletion instruction transmission unit 3003 by the CPU 301 operating with the control program on stored in the ROM 302 and the storage unit 34. It should be noted that some or all of these functions may be realized by hardware such as a dedicated circuit.

The notice reception unit 3001 receives a variety of notices transmitted from the self-service POS terminal 10 to the own device via the communication unit 306. For example, the notice reception unit 3001 receives the cancel notice transmitted from the self-service POS terminal 10.

The annunciation processing unit 3002 provides a variety of announcements to the clerk using the display unit 307. For example, when the notice reception unit 3001 receives the cancel notice, the annunciation processing unit 3002 makes the display unit 307 display an announcement screen for identifying that the cancel operation was performed at the self-service POS terminal 10.

Further, when the other information included in the cancel notice (or together with the cancel notice) is received by the notice reception unit 3001, the annunciation processing unit 3002 makes the display unit 307 display the other information to the clerk. For example, when the terminal ID of the self-service POS terminal 10 is included in the cancel notice, the annunciation processing unit 3002 displays the terminal ID included in the cancel notice on the announcement screen. For example, the information related to the cancel commodity, such as the commodity name, can be included in the cancel notice, the annunciation processing unit 3002 displays the additional information related to the cancel commodity when included in the cancel notice on the announcement screen. Further, for example, when an image of the cancel commodity is obtained and included in the cancel notice, the annunciation processing unit 3002 can display the image included in the cancel notice on the announcement screen.

Thus, the operator of the clerk terminal 30 can see that the cancel operation was performed at the self-service POS terminal 10 by looking at the announcement screen. The operator of the clerk terminal 30 can easily confirm the self-service POS terminal 10 at which the cancel operation was performed, a breakdown of the cancel commodity, the state of the cancel commodity, by looking at the information displayed on the announcement screen.

The deletion instruction transmission unit 3003 transmits the deletion instruction (for deleting the registration of the cancel commodity) to the self-service POS terminal 10 after a confirmation operation has been performed with respect to cancel notice.

Specifically, once the deletion instruction transmission unit 3003 receives the cancel confirmation operation in response to the cancel notice after an operation of the operator via the operation unit 308, the deletion instruction transmission unit 3003 transmits the deletion instruction. Here, the manner of performing the cancel confirmation operation does not particularly matter, and it is possible to adopt a variety of methods. For example, for a button or icon for the cancel confirmation operation may be displayed on the announcement screen, and the deletion instruction transmission unit 3003 may transmit the deletion instruction after the button or icon has been operated (pressed).

With the functional configuration described above, the customer who operates the self-service POS terminal 10 can designate a commodity as a cancel target by performing the cancel operation whenever the commodity which needs to be canceled is identified out of all the commodities registered in the commodity registration. On the other hand, when the cancel operation is performed at the self-service POS terminal 10, the clerk who operates the clerk terminal 30 can see that the cancel operation was performed, the breakdown of the cancel commodity, and so on with the announcement screen. Further, when a cancel confirmation operation by the clerk is performed at the clerk terminal 30, the self-service POS terminal 10 executes the cancel of the registration of the cancel commodity. Further, since the self-service POS terminal 10 and the clerk terminal 30 can execute the processing related to the deletion of the registration of the cancel commodity in the background of the commodity registration, the deletion of the registration of the cancel commodity can be performed without hindering the on-going commodity registration by the customer.

It should be noted that it is assumed that the operator of the clerk terminal 30 (or another clerk) moves to the self-service POS terminal 10 at which the cancel operation was performed in order to collect the cancel commodity on the third loading table 15. The collection timing of the cancel commodity may be before the cancel confirmation operation, or may be after to the cancel confirmation operation.

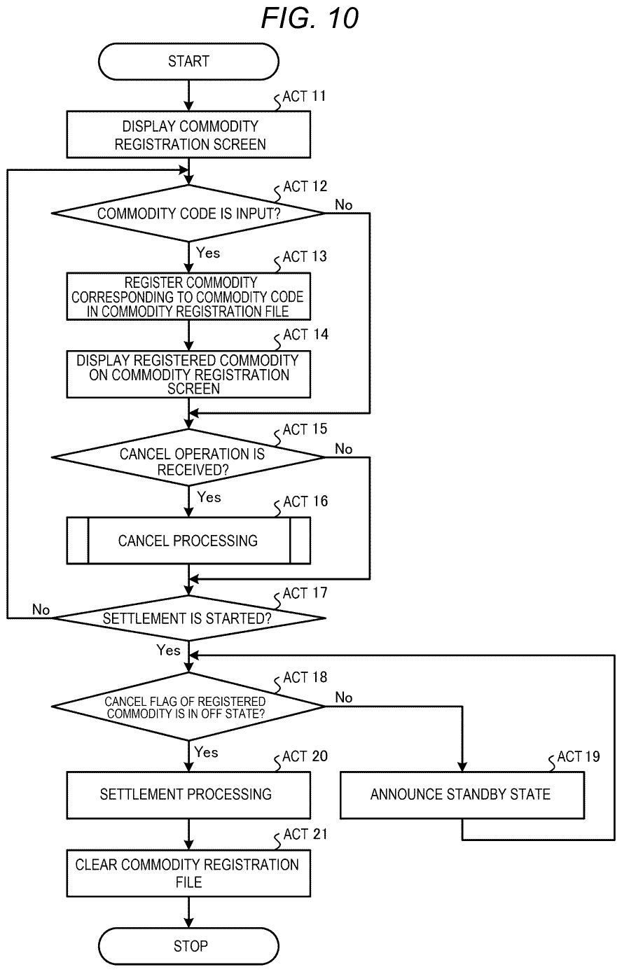

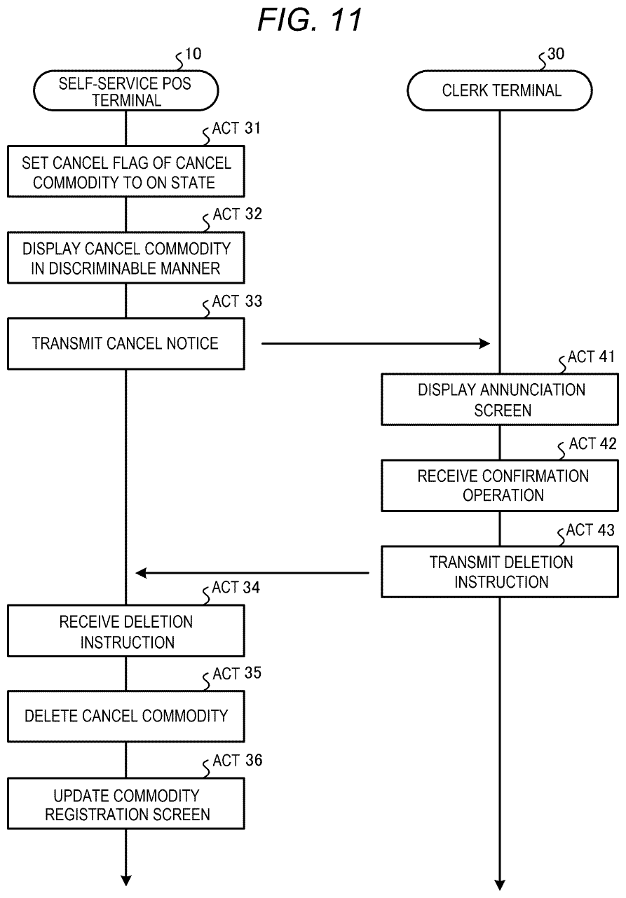

An operation example of the commodity sales data processing system 1 will be described. FIG. 10 is a flowchart showing an example of processing performed by the self-service POS terminal 10 of the embodiment.

When the transaction is started, the commodity registration unit 1002 displays (ACT11) the commodity registration screen on the display unit 21. Subsequently, the commodity registration unit 1002 determines (ACT12) whether a commodity code of a commodity is input via the operation unit 22, the scanner 23, or the like. Here, when it is determined that the commodity code is not input (No in ACT12), the process proceeds to ACT15.

When it is determined that the commodity code is input in ACT12 (Yes in ACT12), the commodity registration unit 1002 registers (ACT13) the commodity information of the commodity corresponding to the commodity code input thereto in the commodity registration file 1043. Subsequently, the commodity registration unit 1002 displays (ACT14) the commodity thus registered on the commodity registration screen, and then proceeds to ACT15.

In ACT15 subsequent thereto, whether the cancel operation reception unit 1005 received the cancel operation is determined (ACT15). Here, when it is determined that the cancel operation was not received (No in ACT15), the process proceeds to ACT17.

On the other hand, when the cancel operation was received (Yes in ACT15), the cancel processing unit 1006 executes the cancel processing in the background (ACT16), and makes the transition of the process to ACT17. It should be noted that the cancel processing in ACT16 will be described below.

Subsequently, the cancel processing unit 1006 determines (ACT17) whether the start of the settlement processing was instructed by an operation of the payment button Bg or the like. When the start of the settlement processing was not instructed (NO in the ACT17), the process returns to ACT12.

Further, when the start of the settlement processing was instructed (Yes in ACT17), the cancel processing unit 1006 determines (ACT18) whether the cancel flags of all the registered commodities registered in the commodity registration file 1043 are in the OFF state. Here, when the registered commodity the cancel flag of which is in the ON state exists (No in ACT18), the cancel processing unit 1006 displays (ACT19), on the display unit 21, a screen for announcing that the standby state is held until the cancel commodity is deleted, and then returns to ACT18.

On the other hand, when the cancel flags of all the registered commodities are in the OFF state (Yes in ACT18), the settlement processing unit 1003 executes (ACT20) the settlement processing based on the total amount of the registered commodities registered in the commodity registration file 1043.

Then, when the settlement processing is completed, the settlement processing unit 1003 clears (ACT21) the commodity registration file 1043 to end the present processing.

An example of the cancel processing to be performed between the self-service POS terminal 10 and the clerk terminal 30 will be described with reference to FIG. 11.

FIG. 11 is a sequence diagram showing an example of the cancel processing performed by the self-service POS terminal 10 and the clerk terminal 30 of the embodiment. It should be noted that the present processing corresponds to the cancel processing in ACT16 shown in FIG. 10.

First, the cancel processing unit 1006 of the self-service POS terminal 10 sets (ACT31) the cancel flag of the cancel commodity designated by the cancel operation to the ON state out of the registered commodities registered in the commodity registration file 1043.

Subsequently, the cancel processing unit 1006 of the self-service POS terminal 10 adds a strike-through, the label L, or the like to the cancel commodity displayed on the commodity registration screen to display (ACT32) the cancel commodity so as to be able to be discriminated from other registered commodities. Subsequently, the cancel processing unit 1006 of the self-service POS terminal 10 transmits (ACT33) the cancel notice to the clerk terminal 30.

In the clerk terminal 30, when the notice reception unit 3001 receives the cancel notice, the annunciation processing unit 3002 makes the display unit 307 display (ACT41) the announcement screen based on the cancel notice. Subsequently, when the deletion instruction transmission unit 3003 receives (ACT42) the cancel confirmation operation from the clerk after the cancel notice, the deletion instruction transmission unit 3003 transmits (ACT43) the deletion instruction to the self-service POS terminal 10.

When the cancel processing unit 1006 of the self-service POS terminal 10 receives (ACT34) the deletion instruction from the clerk terminal 30, the cancel processing unit 1006 deletes (ACT35) the data entry related to the cancel commodity registered in the commodity registration file 1043. Further, the cancel processing unit 1006 of the self-service POS terminal 10 updates the commodity registration screen to display (ACT36) the commodity registration screen which reflects the deletion of the cancel commodity.

As described above, the self-service POS terminal 10 registers the commodity, displays the information related to the registered commodity on the display unit 21, and when the self-service POS terminal receives the cancel operation for designating the cancel commodity to be excluded from the purchase, the self-service POS terminal 10 transmits the cancel notice to the clerk terminal 30, and then executes the deletion of the registration in accordance with the instruction from the clerk terminal 30. Further, the self-service POS terminal 10 executes the processing related to the deletion of the registration of the cancel commodity in the background of the registration processing.

Thus, at the self-service POS terminal 10, when canceling a previously registered commodity, it is possible for the customer to designate a commodity to be canceled from the transaction by performing a cancel operation. Further, at the self-service POS terminal 10, the deletion of the registration of the now-canceled commodity can be executed in the background of the registration processing. Therefore, at the self-service POS terminal 10, it is possible for the customer to perform a cancellation of a previously registered commodity while continuing the registration operations for other commodities without waiting for an operation by the clerk (attendant). Therefore, with the self-service POS terminal 10, it is possible to improve the convenience and the efficiency of the operations related to the canceling of a commodity while making it possible for the customer or the like to continue efficiently performing the registration of other commodities in the sales transaction.

It should be noted that embodiments can also be implemented with appropriate modifications by changing aspects of the configurations of or the functions provided by each device described above. Some modified examples will be described as other embodiments below. It should be noted that aspects different from those of the examples already described above will mainly be described, and aspects common to those already described, may be omitted from further description. Furthermore, the modified examples may individually be implemented or may be implemented in combination with one another as appropriate.

### MODIFIED EXAMPLE 1

In an embodiment, the commodity sales data processing apparatus is a self-service POS terminal 10 of a fixed, stationary type, but this is not a limitation. For example, the commodity sales data processing apparatus may be a registration apparatus of a self-service POS system in which the registration apparatus and a payment apparatus (for performing the settlement operation) are separate. Similarly, the commodity sales data processing apparatus may be a portable terminal with which the customer performs the registration operation of commodities by him-or herself using the portable terminal (e.g., a smartphone). In other examples, the portable terminal (e.g., a tablet terminal) may be attached to a shopping cart.

### MODIFIED EXAMPLE 2

In an embodiment, the self-service POS terminal 10 has a configuration in which the deletion of the registration of a cancelled commodity is performed with the deletion instruction from the clerk terminal 30, but this is not a limitation, and it is possible to adopt a configuration in which the deletion of the registration is performed in accordance with an operation of a clerk via the operation unit 22.

When adopting the present modified example, the cancel processing unit 1006 of the self-service POS terminal 10 determines that the deletion instruction is received when some predetermined operation (a confirmation operation) is performed via the operation unit 22 after the transmitting of the cancel notice to the clerk terminal 30. Then, the cancel processing unit 1006 performs the deletion similarly to already described above.

It is preferable for the confirmation operation to be an operation which can be executed only by the clerk. For example, the confirmation operation may be an operation which can be executed only when a clerk ID and a password have been input, and the authentication is successful.

Thus, the clerk can perform a confirmation operation for the deletion instruction in conjunction with the collection of the cancel commodity at the self-service POS terminal 10, it is possible to efficiently perform the confirmation and the collection work for the cancel commodity.

### MODIFIED EXAMPLE 3

In an embodiment described above, the cancellation can be performed by class (commodity code) of commodity, but it is possible to adopt a configuration in which the cancellation can be performed for some but not all items sharing the same commodity code.

For example, when the cancel operation reception unit 1005 receives a subtraction operation for decreasing the registered number of the same commodity displayed in the commodity display region Gc, the cancel operation reception unit 1005 receives notice of the commodity being subjected to the subtraction operation as a cancel commodity identification. The cancel operation reception unit 1005 then receives the number of instances to be subtracted by the subtraction operation as the number the cancel commodity. Further, when the cancel operation reception unit 1005 receives the cancel operation based on the image acquired by the image acquisition unit 1004, the cancel operation reception unit 1005 can recognize the cancel commodity from the image and, at the same time, count the number of instances of the cancel commodity (with same commodity code) appearing in the image.

When the cancel processing unit 1006 sets the cancel flag of the cancel commodity to the ON state, the cancel processing unit 1006 stores the cancel flag in association with the number of instances of the cancel commodity in the commodity registration file 1043. Further, the cancel processing unit 1006 subtracts the number of instances (pieces) of the cancel commodity from the number stored in the number of pieces field of the commodity registration file 1043 and sets the cancel flag to the OFF state in accordance with the deletion instruction from the clerk terminal 30. Further, when the value after the subtraction is “0,” the cancel processing unit 1006 deletes the data entry of the cancel commodity similarly to the embodiment described above.

Thus, since a cancellation can be performed by individual pieces/instances of the commodity (e.g., same commodity code), it is possible to achieve an improvement of the convenience related to such a cancellation of some but not all of the commodity sharing the same commodity code or the like.

In the present modified example, it may be preferable to display the cancel commodity type and the number of pieces/instances of the cancel commodity type in a discriminable manner within the commodity registration screen displayed whenever the cancel operation is received. For example, the cancel processing unit 1006 may add the label L to a cancel commodity entry out of all the commodities displayed in the commodity display region Gc, and also show the number of pieces/instances of the cancel commodity. As an example, it is possible to show the number of pieces of the cancel commodity in a format such as “2-1 pieces” by displaying the original number of registered pieces and the number of pieces being cancelled with a minus sign therebetween.

Further, a program to be executed in each apparatus in the embodiments described above can be incorporated in advance in a storage medium (the ROM or the storage unit) in the apparatus, but this is not a limitation. For example, it is possible for a program to be recorded on a computer-readable recording medium such as a CD-ROM, a flexible disk (FD), a CD-R, or a DVD as a file in an installable format or an executable format and transferred separately. A program may be transmitted, downloaded, accessed, distributed or the like via a LAN, the Internet, or the like.

Further, a program to be executed in each of the apparatuses in an embodiment can be stored in a computer connected to a network such as the Internet, and then downloaded or delivered via the network.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the present disclosure.

What is claimed is:

1. A commodity sales data processing apparatus, comprising:
a communication interface connectable to a clerk terminal apparatus;
a storage unit; and
a control unit configured to:
receive a commodity code of an item being registered for purchase in a sales transaction,
extract commodity information associated with the received commodity code from a commodity master,
register the commodity code and the extracted commodity information for the item in a transaction file associated with the sales transaction in the storage unit,
cause commodity information related to the item to be displayed on a commodity registration screen,
receive a cancelation operation requesting a cancelation of the item from the sales transaction,
output a cancelation notification to the clerk terminal apparatus via the communication interface, and
indicate a deletion of the registered item in the transaction file for the sales transaction upon receiving a clerk cancelation confirmation instruction, wherein
the control unit is further configured to receive commodity codes of other items being registered for purchase in the sales transaction after the cancelation notification has been output but before receiving of the clerk cancelation confirmation instruction.

2. The commodity sales data processing apparatus according to claim 1, wherein the cancelation notification includes the commodity code of the item subjected to the cancelation operation.

3. The commodity sales data processing apparatus according to claim 1, wherein the commodity code of the item subjected to the cancelation operation is output along with the cancelation notification to the clerk terminal apparatus.

4. The commodity sales data processing apparatus according to claim 1, further comprising:
an imaging unit configured to provide images of a designated cancelation region into which items can be placed when being canceled from the sales transaction.

5. The commodity sales data processing apparatus according to claim 4, wherein the control unit is further configured to:
acquire an image of the designated cancelation region,
identify the item within the designated cancelation region based on the acquired image, and
include the commodity code of the identified item in the cancelation notification.

6. The commodity sales data processing apparatus according to claim 5, wherein the control unit is configured to:
output the acquired image with the cancelation notification to the clerk terminal apparatus.

7. The commodity sales data processing apparatus according to claim 1, further comprising:
a display unit for displaying the commodity registration screen, wherein
the control unit is configured to:
display information related to the canceled item in a discriminable manner within a list of items registered in the sales transaction on the commodity registration screen.

8. The commodity sales data processing apparatus according to claim 1, wherein the cancelation operation is the placing of the item in a designated cancelation area.

9. The commodity sales data processing apparatus according to claim 1, wherein the cancelation operation is a selection of the item from a list of items displayed on the commodity registration screen.

10. A point of sale terminal, comprising:
a commodity scanner;
a display screen for displaying information to an operator of the point of sale terminal during a sales transaction;
a designated cancelation region into which the operator may place items to be canceled from the sales transaction;
an imaging unit positioned to image items in the designated cancelation region;
a communication interface connectable to a clerk terminal apparatus;
a storage unit for storing a commodity master and a transaction file; and
a control unit configured to:
receive a commodity code of an item being registered for purchase in the sales transaction via the commodity scanner,
extract commodity information associated with the received commodity code from the commodity master,
register the commodity code and the extracted commodity information for the item in the transaction file associated with the sales transaction in the storage unit,
cause commodity information related to the item to be displayed on a commodity registration screen on the display screen,
receive a cancelation operation requesting a cancelation of the item from the sales transaction,
output a cancelation notification to the clerk terminal apparatus via the communication interface, and
indicate a deletion of the registered item in the transaction file for the sales transaction upon receiving a clerk cancelation confirmation instruction, wherein
the control unit is further configured to receive commodity codes of other items being registered for purchase in the sales transaction after the cancelation notification has been output but before receiving of the clerk cancelation confirmation instruction.

11. The point of sale terminal according to claim 10, wherein the cancelation operation is the placing of the item in the designated cancelation area.

12. The point of sale terminal according to claim 10, wherein the cancelation operation is a selection of the item from a list of items displayed on the commodity registration screen.

13. The point of sale terminal according to claim 10, wherein the commodity code of the item subjected to the cancelation operation is output along with the cancelation notification to the clerk terminal apparatus.

14. The point of sale terminal according to claim 10, wherein the control unit is further configured to:
acquire an image of the designated cancelation region,
identify the item within the designated cancelation region based on the acquired image, and
include the commodity code of the identified item in the cancelation notification.

15. The point of sale terminal according to claim 10, wherein the control unit is further configured to:
acquire an image of the designated cancelation region,
identify the item within the designated cancelation region based on the acquired image, and
include the commodity code of the identified item in the cancelation notification.

16. The point of sale terminal according to claim 10, wherein the clerk cancelation confirmation instruction is transmitted from the clerk terminal apparatus.

17. A point of sale system, comprising:
a clerk terminal apparatus; and
a plurality of point of sale terminals according to claim 10.

18. A method for a commodity sales data processing apparatus, the method comprising:
receiving a commodity code of an item being registered for purchase in a sales transaction;
extracting commodity information associated with the received commodity code from a commodity master;
registering the commodity code and the extracted commodity information for the item in a transaction file associated with the sales transaction in a storage unit;
causing commodity information related to the item to be displayed on a commodity registration screen;
receiving a cancelation operation requesting a cancelation of the item from the sales transaction;
outputting a cancelation notification to a clerk terminal apparatus via a communication interface;
indicating a deletion of the registered item in the transaction file for the sales transaction upon receiving a clerk cancelation confirmation instruction from the clerk terminal apparatus; and
receiving commodity codes of other items being registered for purchase in the sales transaction after the cancelation notification has been output but before the receiving of the clerk cancelation confirmation instruction.

19. The method according to claim 18, wherein the cancelation notification includes the commodity code of the item subjected to the cancelation operation.

20. The method according to claim 18, the method further comprising:
acquiring an image of a designated cancelation region,
identifying the item within the designated cancelation region based on the acquired image; and
including the acquired image and the commodity code of the identified item in the cancelation notification.
